(19) United States
(12) Patent Application Publication
(10) Pub. No.: US 2015/0279225 A1
(43) Pub. Date: Oct. 1, 2015

(54) METHOD FOR INDIVIDUALLY CUSTOMIZING PRESENTATION OF FORUM POSTINGS IN A MOOCS SYSTEM BASED ON CUMULATIVE STUDENT COURSEWORK DATA PROCESSING

(71) Applicant: KONICA MINOLTA LABORATORY U.S.A., INC., San Mateo, CA (US)

(72) Inventor: Daniel Barber, San Francisco, CA (US)

(73) Assignee: KONICA MINOLTA LABORATORY U.S.A., INC., San Mateo, CA (US)

(21) Appl. No.: 14/229,723

(22) Filed: Mar. 28, 2014

(51) Int. Cl. G09B 7/00; G06F 17/30

(52) U.S. Cl. CPC G09B 7/00; G06F 17/30312; G06F 17/30554; G06F 17/3053

(57) ABSTRACT

A method for managing a forum of a MOOCs (Massive Open Online Courses) system customizes the presentation of forum questions to each individual viewing student in a way that optimizes the likelihood of questions posted on the forum being answered by competent students. The system rates the students' academic abilities using information gathered from their activities on the MOOCs system. When a student browses the forum, the forum questions are sorted and presented to the viewing student in an order that takes into account the subjects of the questions and the student's academic ability in various subjects, so that questions on subjects in which the student excels are displayed near the top of the list of postings. The sorting may consider other factors including language, locale, past forum activities, and proximity of the questions posting time and the time period when the viewing student frequently accesses the forum.

### BACKGROUND OF THE INVENTION

1. Field of the Invention

This invention relates to online forums, and in particular, it relates to a method of customized presentation of forum postings to individual users for a MOOCs forum.

2. Description of Related Art

MOOCs, or Massive Open Online Courses, are online educational institutions that serve millions of students worldwide. A MOOCs system provides online education by having students read, view or interact with educational materials online, as well as take tests online. By their very nature, MOOCs have thousands of students enrolled, but typically only a fraction of the students finish. One of the main reasons identified by students that they do not complete the courses is that they are unable to get the help they need when they find the course content difficult. Current MOOCs systems use web forums as a predominant way to address student's questions. Students (users) can post questions or requests for help on the forum, and other students (users) may voluntarily answer any of the posted questions. This system tends to be inefficient and hard to use, and often leads to student's questions going unanswered. Thus, students often do not get the help they need, and often do not complete the courses they are taking.

### SUMMARY

The present invention is directed to a method of managing forums of a MOOCs system that customizes the presentation of forum questions to each viewing user in a way that optimizes the likelihood of questions posted on the forum being answered by competent students.

An object of the present invention is to promote a better learning environment on a MOOCs forum.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a MOOCs (Massive Open Online Courses) system for processing questions posted on an online forum of the MOOCs system, the MOOCs system including one or more server computers providing web-based educational materials, the method being implemented on the server computers, which includes: (a) storing, in a database, information about each of a plurality of students registered with the MOOCs system, including their academic abilities in each of a plurality of subjects of study; (b) receiving a plurality of questions posted on the online forum; (c) receiving a browsing command from a viewing student among the plurality of students to browse the forum; (d) for each of the questions on the online forum, calculating a relationship score with respect to the viewing student based on stored academic ability of the viewing student in a subject of the question; (e) in response to the browsing command from the viewing student, generating a sorted list of all forum questions in which the forum questions are sorted based at least partly on the relationship scores of the questions with respect to the viewing student; and (f) transmitting the sorted list of all forum questions to the viewing student.

The relationship score in step (d) may be further based on the language and locale information, past forum activities information, and online access history. The online access history may include numbers of the viewing user's logon events on a 24 hour scale, and the relationship score may be based on a relative frequency of the logon events of the viewing student in a predetermined time period of the 24 hour scale centered at or starting from a time the question was posted.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates an online forum management method implemented in a MOOCs system according to an embodiment of the present invention.

FIG. 2 schematically illustrates a method for calculating academic scores reflecting academic abilities of students according to an embodiment of the present invention.

FIG. 3 illustrates exemplary academic scores for a number of students.

FIG. 4 schematically illustrates a MOOCs system in which embodiments of the present invention may be implemented.

### DETAILED DESCRIPTION OF PREFERRED EMBODIMENTS

An online forum is a platform that allows its users to exchange information, where each user can publicly post comments or questions (postings) that can be read by all other users, and users can reply to any users' postings. In the following descriptions, a forum managed as a part of a MOOCs system is used an example of an online forum, and the users are referred to as students, but the invention is not limited to MOOCs.

Embodiments of the present invention provide an improved online forum presentation method in which questions posted on the online forum are presented to individual students (users) in an intelligent manner. More specifically, each student is rated according to their academic abilities in various subjects; when a student logs on to the forum, the questions posted by others are presented to the student in an order that takes into account the subjects of the questions and the student's academic ability in various subjects, so that questions on subjects in which the student is an expert will be displayed to the student with higher priorities, e.g. near the top of the list of all postings on the forum. A sorting algorithm is implemented when presenting the questions on the forum to each individual student. The purpose is to present forum questions to students in a manner so that the questions are more likely to be seen and therefore answered by competent students.

In a conventional MOOCs system, all students who access a forum would see the same list of discussion threads on the forum in the same order. Typically the postings or discussion threads are presented in a reverse chronological order with the most recent postings at the top. This can causes information overload when the number of postings is large, and often results in many questions not being answered because they are quickly pushed down the list of postings and are never seen by most students who log on to the forum only for a limited amount of time each day. Thus, it is often the case that even though there are many students who are competent in the subject and can answer a question, the question goes unanswered because it is not seen by many students.

Embodiments of the present invention minimize these problem by providing a sorting algorithm that personalizes the sorting of postings to be presented for each student (the viewing user). In other words, different users, when accessing the same web page of the online forum, will be presented postings in different orders. For example, if student 1 is an expert in topic A but poor in topic B, questions posted by others concerning topic A will be displayed for student 1 near the top of the list of postings when she logs on to the forum, but questions posted by others concerning topic B will be displayed for student 1 at relatively later positions of the list.

To enable the sorting algorithm, information about individual students, including, for example, their academic abilities in various subjects of study, their forum activity histories (e.g., how often do they answer other student's questions), their online access histories, etc., is gathered, stored in a database and analyzed to determine how postings on the forum will be sorted and displayed to each student. Online access history (pattern) of a student refers to the time of the day and/or week during which the student frequently accesses the MOOCs system. The gathering and processing of student information is described in more detail later.

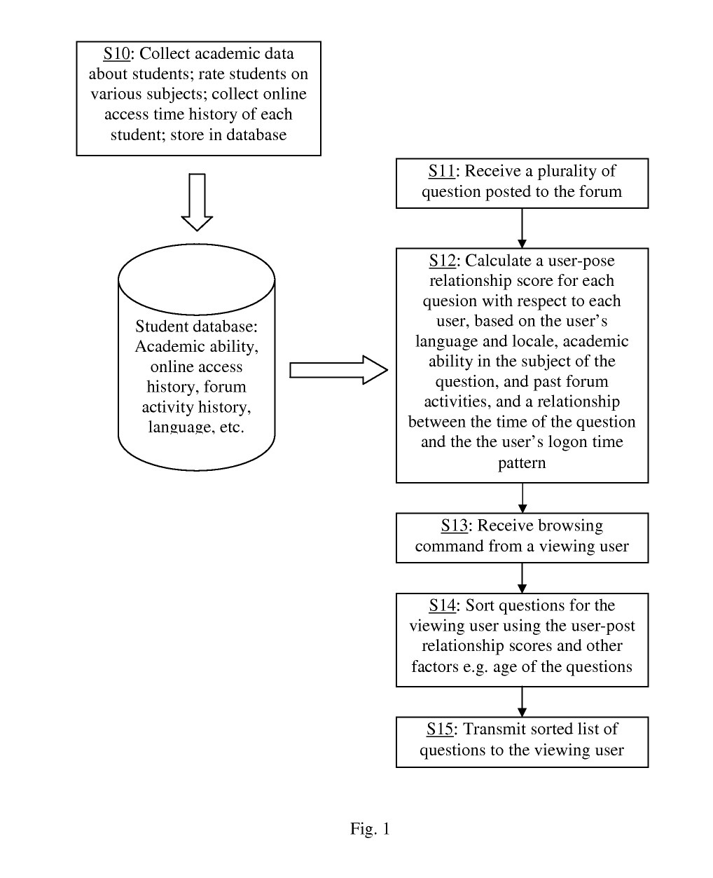

Using the gathered and analyzed data about the students, an online forum question presentation method according to embodiments of the present invention can sort all questions on a forum when presenting them to each individual student, as described below with reference to FIG. 1.

The MOOCs forum receives a plurality of questions in the form of forum posts (step S11). The system calculates a user-post relationship score for each active (non-closed, or unanswered) question with respect to each viewing student (step S12). The user-post relationship score is calculated by taking into account a number of factors, including: the language of the post vs. that of the viewing student, the locale (the user computer's locale settings, such as keyboard layout, language, time zone, etc.) of the viewing student, the academic ability of the viewing student in the subject of the question (the subject of the question may be designated by the student who asked the question), the viewing student's past forum activities (e.g. how many questions they answer for other students), and a time matching factor that reflects whether the time the question was posted is close to a time of the day and/or week when the viewing student frequently accesses the forum, etc.

Generally, the user-post relationship score will be higher if the viewing student uses the same language and/or locale as the student who asked the question, has high academic ability in the subject of the question, and in the past answered questions in this subject at a relatively high rate. In addition, the score will be higher if the time the question was posted is close to a time period of the day and/or week that the viewing user frequently accesses the forum. The proximity in time of the posting user and viewing user's activities may imply certain relationship or correlation between these users.

In one particular implementation, the user-post relationship score starts from a base start point (e.g. 0.5); it is decreased by a value (e.g. 0.4) if the viewing student does not speak the same language as the asking student; decrease by 0.1 if the viewing student does not have the same locale as the asking student; increased by 0.1 if the relative frequency that the viewing student logs on to the system during a predetermined time period after the time of the question exceeds a value; adjusted by an appropriate value (e.g. from 0.2 to −0.2) depending on the academic ability of the viewing student (e.g., rated at five levels from expert to poor); and increased by 0.1 if the viewing student answers questions in this subject at a rate of more than 1 per day, etc. Of course, other formulas can be used to calculate the user-post relationship score.

In one particular example, the algorithm for calculating the user-post relationship score may be expressed in the following formula (Eq. (A)):

C_{base}+(φ_{lang}→M₁)+(φ_{loc}→M₂)+(φ_{Time}→M₃)+(φ_{SRate1}→M₄⊕φ_{SRate2}→M₅)+(φ_{SRate3}→M₆⊕φ_{SRate4}→M₇)+(φ_{Acnt}→M₈)

The notations used in this formula are as follows: each φ represents an event or condition; each M represents a value; and the notation “φ→M” means that if the condition φ is true then the value M is assigned. The notation “⊕” means “or”. The meanings of the various parameters and values in Eq. (A) are as below (here, “user” refers to the user for whom the score is being calculated, i.e. the viewing user, and “the posting user” refers to the user who posted the question):

C_{base}=base start point

φ_{lang}=User's language is the same as that of the posting user

φ_{loc}=User's locale is the same as that of the posting user

φ_{Time}=Posting time of the question matches user's online access pattern

φ_{SRate1}=User is considered good in the topic

φ_{SRate2}=User is considered bad in the topic

φ_{SRate3}=User is considered an expert in the topic

φ_{SRate4}=User is considered poor in the topic

φ_{Acnt}=User answers questions on this topic at a rate of more than 1 per day

M₁=language match modifier

M₂=Locale modifier

M₃=Time Access modifier

M₄=Good user Rating Modifier

M₅=Bad user Rating Modifier

M₆=Expert user Rating Modifier

M₇=Poor user Rating Modifier

M₈=Answer Rate Modifier

In the above formula, φ_{Time} is the time matching factor that reflects whether the time of the question (the time of the day it was posted) matches the viewing user's forum access pattern. φ_{Time} is true if within a predetermined time duration A (e.g. 1 hour, 2 hours, etc.) centered at the time T of the posting, the relative frequency of viewing user's logon events exceeds a certain threshold value. To calculate the relative frequency of logon events, the system collects and stores each user's online access history, including the logon time and (optionally) duration of each online session. The logon events may be rounded to a series of regular time points such as the nearest 10-minute points (e.g. 13:23 is rounded to 13:20), the nearest hour (e.g. 20:43 is rounded to 21:00), etc. For each user, the number of logon events at each of the regular time points on a 24-hour scale may be stored. For the question that was posted at time point T, the relative frequency of a particular viewing user′ logon event is the total number of the student's logon events that fall within the time period from T−Δ/2 to T+Δ/2 divided by the total number of the student's logon events. In other words, it is the percentage of all logon events of this student that occur within the relevant time period on the 24-hour scale. Care should be taken when the time duration from T−Δ/2 to T+Δ/2 crosses midnight; in such situations, the logon events falling in both the periods from T−Δ/2 to 24:00 and the period from 0:00 to T+Δ/2-24 on the 24-hour scale should be used to calculate the relative frequency. φ_{Time} is true if the relative frequency is greater than a predetermined value, for example, 68% (one standard deviation) when A is 2 hours. In an alternative embodiment, the relevant time period may be defined as the time duration A starting from the time T of the posting.

The user-post relationship score is calculated for each posting with respect to each student. In one embodiment, the calculation is done shortly after each question is posted, and the user-post relationship scores with respect to all students are stored in the system. In another embodiment (preferred), the user-post relationship scores with respect to each viewing user are calculated after the viewing user browses to the forum. The latter method may be more efficient as it may avoid unnecessary calculation of the scores. For example, the sorting criteria (see example below) may be such that questions older than a certain age are not sorted; thus, for students who access the forum infrequently, calculating the scores for all questions with respect to them may be wasteful.

When a student browses to the forum (step S13), the system sorts all the questions on the forum using the user-post relation scores of the questions with respect to this student as well as other factors (step S14), and transmits the sorted list of questions to the student's browser (step S15). In one implementation, the sorting is a weighted sort using the user-post relationship score and the age of the post.

In one particular example, the posts are first sorted into three groups by the user-post relationship score and age: The first group contains posts having a score greater than a first value (e.g. 0.8) and are less than a certain age (e.g. 2 days old); the second group contains posts having a score between a second value and the first value (e.g. 0.5-0.8) and are less than the certain age; and the third group contains posts having a score below the second value (e.g. 0.5) and all other posts older than the certain age. Then, within each group, the postings are sorted in a reverse chronological order with the newest at the top. The three groups are then combined in that order to form a single list. Of course, this is only an example; other suitable ways of sorting the posts may be used.

The sorted list of questions is presented to the viewing student when she logs on and browses to the forum (step S14). In a preferred embodiment, the sorted list is generated on the fly by the server and transmitted to the viewer's browser; the sequence of questions on the forum is not modified, and the sorted list is not stored. When the user re-loads the forum page, the sorting is updated.

It should be noted that the presentation of sorted list of forum postings in steps S14 and S15 is different from a “recommended for you” type of display on some shopping websites. The “recommended for you” feature are implemented as filters that selects a number of items from a large pool of items; the method described here provides a sorting of all items rather than a filter that selects items from a pool. Similarly, the sorting method is different from a query or search, the latter again being a filtering process. The sorting method is also different from an assignment which assigns the question to one or more suitable users to be answered; in an assignment situation, the question is only directed to the assigned users and the other users will not see the question. In addition, the sorting and presentation steps (S13 and S14) are performed automatically, rather than in response to as a request from the user.

As mentioned earlier, one of the factors used to calculate the sorting score for sorting forum questions (step S10) is each student's academic abilities in various subjects of study. Here, “subjects” may be defined at any suitable levels, such as biology vs. history, different areas of biology or history, or different sections or topics within a course, etc. Subjects may be identified based on the syllabus; for example, each course, or each section within each course, may be identified as a subject.

The academic abilities of each student are obtained by collecting and analyzing a large and detailed dataset from the MOOCs system (step S10 of FIG. 1). Some examples of the academic information to be collected and analyzed include:

Test related data: The MOOCs system provides various online (automated) tests for each course or each section of a course, and students are scored on these tests. Test related data of each student are collected, including test scores, time to completion (how long it takes the student to complete a test), the number of times each test is retaken by the student (a MOOCs often allows each student to take a test multiple times e.g. to improve their scores), results of individual question within a test, etc. There are typically different types of tests, including more informal ones (often referred to as quizzes) and more formal ones. Quizzes are typically given more frequently, and tests are typically given less frequently, such as once or twice for each course.

Homework related data: The MOOCs system require students to complete homework assignments which are then graded. Each student's grade for homework assignments and individual question results within each homework assignment (if available) are collected.

Page work related data: MOOCs students study their subjects by reading, viewing or practicing study materials online. The study materials may be text, images, video, interactive web pages, etc. The time a student spends on a unit of materials is collected. For example, a section or chapter of the study material may be presented as a web page, and the time a student spends on the web page may be collected, to the largest extent possible. For convenience, this data is referred to as page work related data here.

Data about postings on the forum: As mentioned before, MOOCs have forums for their students to use to ask questions and get help. The forum is preferably moderated (e.g. abusive postings may be removed), topic sorted, and question driven. On such a forum, users' answers can be rated by the moderator, by the asker or by other users as to whether they are correct or helpful. Here, data about questions each student asks on the forums, questions each student successfully or correctly answers for other students, and what topics the questions relate to, are collected.

The timestamp of all the above student events for each event may be collected as well.

In addition, information about the geographical location (e.g., latitude/longitude, physical address, country, city, IP address, etc.) and locale (the user computer's locale settings, such as keyboard layout, language, time zone, etc.) of each student may be collected. Such information may be obtained from the students during a registration process, and/or from the IP addresses of the computers they use to access the MOOCs system, etc.

The above data is collected on each individual student. The students are identified by the user IDs.

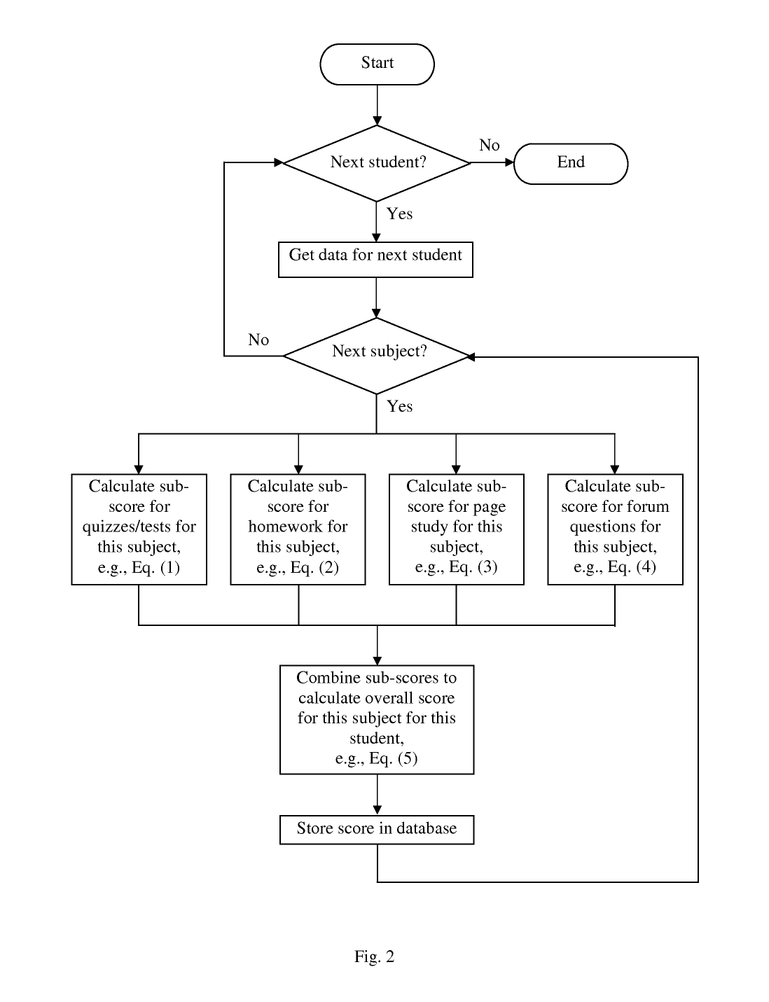

The data about individual student is processed to calculate a score of each student on each subject of study, as described below with reference to FIG. 2. For each student and each subject (e.g. subject A), first, test related data is used to calculate a first sub-score. Generally, this sub-score will be higher if the student passed the test on first try, got all questions correct on first try, completed the tests in a relatively short amount of time, and/or scored high in the test, etc.; and lower if the student completed the test in a relatively long amount of time, did not pass the test, got no questions correct, retook the test and failed again, and/or scored low in the test, etc. The results from all tests taken by the student on the subject are accumulated.

In one particular example, for each test, starting from a base score of 0.5, the sub-score is increased or decreased as follows:
Passed on first try: +0.2
Got all questions correct on first try +0.3
Completed quiz/test outside of 1 standard deviation of time compared to other students (+0.1 or −0.1 for faster or slower, respectively)
Didn't Pass: −0.2
Got no questions correct −0.3
Retook quiz/test and failed again: −0.1
Score modifier: if student's score is 1 standard deviation or more from the average, add or subtract 0.1 from the score for higher or lower, respectively.

Using these exemplary values, for each test, an expert on the topic may get a score of 1 and a novice with no experience at all on the topic may get a score of 0.

In one particular example, the algorithm for calculating this sub-score is expressed by the following formula (Eq. (1)):

$${C}_{1} = \sum [ {C}_{base} + ( {ϕ}_{isQuiz} \to {M}_{0} ⊕ {ϕ}_{isTest} \to {M}_{1} ) ( ( {ϕ}_{First} \to {M}_{2} ) + ( {ϕ}_{Perfect} \to {M}_{3} ) + ( ( {ϕ}_{time} > λ + {σ}_{time} \to {M}_{4} ) ⊕ ( {ϕ}_{time} < λ - {σ}_{time} \to {M}_{5} ) ) + ( {ϕ}_{Failed} \to {M}_{6} ) + ( {ϕ}_{None} \to {M}_{7} ) + ( {ϕ}_{retook} \to {M}_{8} ) + ( ( {ϕ}_{Score} > μ + {σ}_{Score} \to {M}_{9} ) ⊕ ( {ϕ}_{Score} < μ - {ϕ}_{Score} \to {M}_{10} ) ) ) ]$$

The notations used in this formula are as follows: each φ represents an event or condition; each M represents a value; and the notation “φ→M” means that if the condition φ is true then the value M is assigned. The notation “⊕” means “or”. The sum is over all tests on the subject A taken by the student. The meanings of the various parameters and values in Eq. (1) are as below:

C_{base}=Base start point

φ_{isQuiz}=If the task is a quiz

φ_{isTest}=If the task is a test

φ_{First}=If the user passed on the first try

φ_{Perfect}=If the user received a perfect score

φₜᵢₘₑ=The time taken by the user to complete the task

φ_{Failed}=If the user failed the task

φ_{None}=If the user got 0 questions correct

φᵣₑₜₒₒₖ=If the user retook the task and failed again

φ_{Score}=The user's score

M₀=Quiz Modifier

M₁=Test Modifier

M₂=First Try Modifier

M₃=Perfect Score Modifier

M₄=Time Modifier positive

M₅=Time Modifier negative

M₆=Fail Modifier

M₇=0% Modifier

M₈=Retake Modifier

M₉=Score Modifier positive

M₁₀=Score Modifier negative

λ=Mean or Average Time to Complete task for all students

μ=Mean or Average Score for task for all students

σₜᵢₘₑ=1 Standard Deviation of Time for task completion

σ_{Score}=1 Standard Deviation of Score for task

As expressed in this formula, for each test, the formula calculates a score by starting from a base score C_{base} which is then modified by various modifier values M based on various events or conditions φ relating to tests. For example, if the student passes the test on the first try, the score is modified by M₂ (φ_{First}→M₂). Each term is weighted by a weighting factor M₀ or M₁ depending on whether the task is a more informal one (a quiz) or a more formal one (a test) (φ_{isQuiz}→M₀⊕φ_{isTest}→M₁). Of course, other types of testing may be designated and given their weights; or, different types of testing may be given the same weight. In one particular example, each quiz is given a weight of M₀=0.5, and each test is given a weight of M₁=1. The values given to the various modifiers M in Eq. (1) correspond to the nature of the corresponding conditions or events; some examples are given above.

Second, homework related data is used to calculate a second sub-score. Generally, this sub-score will be higher if the student completed the homework on first try, completed the homework correctly on first try, completed the homework in a relatively short amount of time, and/or received a high grade in the homework, etc.; and lower if the student completed the homework in a relatively long amount of time, did not complete the homework, did the homework incorrect, re-did the homework and failed to complete it again, and/or received a low grade in the homework, etc. The results from all homework assignments on the subject are accumulated.

In one particular example, for each homework assignment, starting from a base score of 0.5, the sub-score is increased or decreased as follows:
Completed on first try: +0.2
Got the entire homework correct on first try +0.3
Completed homework outside of 1 standard deviation of time compared to other students (+0.1 or −0.1 for faster or slower, respectively)
Didn't complete: −0.2
Got no part of the homework correct −0.3
Score modifier: if student's score is 1 standard deviation or more from the average, add or subtract 0.1 from the score for higher or lower, respectively

Using these exemplary values, for each homework assignment, an expert on the topic may get a score of 1 and a novice with no experience at all on the topic may get a score of 0.

In one particular example, the algorithm for calculating this sub-score is expressed by the following formula (Eq. (2)):

$${C}_{2} = \sum [ {C}_{base} + ( {ϕ}_{First} \to {M}_{2} ) + ( {ϕ}_{Perfect} \to {M}_{3} ) + ( ( {ϕ}_{time} > λ + {σ}_{time} \to {M}_{4} ) ⊕ ( {ϕ}_{time} < λ - {σ}_{time} \to {M}_{5} ) ) + ( {ϕ}_{Failed} \to {M}_{6} ) + ( {ϕ}_{None} \to {M}_{7} ) + ( ( {ϕ}_{Score} > μ + {σ}_{Score} \to {M}_{9} ) ⊕ ( {ϕ}_{Score} < μ - {ϕ}_{Score} \to {M}_{10} ) ) ) ]$$

The notations have the same general meaning as in Eq. (1), and the sum is over all homework tasks the student did on subject A. The meaning of the various parameters and values in Eq. (2) are the same as or similar to the corresponding items described for Eq. (1), except that the task now refers to homework task, and that the “retake” modifier M₈ is not used in Eq. (2). Also, all homework tasks are assigned the same weight (e.g. 0.5) which is not present in Eq. (2) but will be included when calculating the overall score later. In one particular example, the various modifier values are the same as described above for Eq. (1) except for the absence of Mg.

Third, page work related data is used to calculate a third sub-score. Generally, this sub-score will be higher (or lower) if the student completed a page of study material in a relatively short (or long) amount of time. The results from all pages of study materials on the subject are accumulated.

In one particular example, for each page of study materials, starting from a base score of 0.5, the sub-score is increased or decreased by 0.1 if the student completed the page faster or slower than 1 standard deviation of other students, respectively.

In one particular example, the algorithm for calculating this sub-score is expressed by the following formula (Eq. (3)):

C₃=Σ[C_{base}((φₜᵢₘₑ>λ+σₜᵢₘₑ→M₄)⊕(φₜᵢₘₑ<λ−σₜᵢₘₑ→M₅))]

The notations have the same general meaning as in Eq. (1), and the sum is over all page tasks the students performed (e.g. read, viewed, etc.) on subject A. The meaning of the various parameters and values in Eq. (3) are the same as or similar to the corresponding items described for Eq. (1) except that the task now refers to a page task, i.e., reading or viewing a page of material. In one particular example, the time modifiers M₅ and M₄ have the same values as described above for Eq. (1).

Fourth, forum related data is used to calculate a fourth sub-score. Generally, this sub-score will be higher if the student attempted to answer questions on the subject, and/or if her answers are verified or accepted by others; and lower if she asked questions on the subject. The results from all forum questions are accumulated.

In one particular example, starting from a base score of 0.5, the sub-score is increased or decreased as follows:
Asks a question on topic A: −0.1
Attempts to answer question on topic A: +0.1
“verified” or “accepted” answer on topic A: +0.3

In one particular example, the algorithm for calculating this sub-score is expressed by the following formula (Eq. (4)):

C₄=ΣC_{base}+(φₐₛₖ→M₁₁)+(φ_{answer}→M₁₂)+(φ_{Accepted}→M₁₃)

The notations have the same general meaning as in Eq. (1), and the sum is over all questions that the user asked and answered on the forum on subject A. The meaning of the various parameters and values in Eq. (2) are as below:

C_{base}=Base start point

φₐₛₖ=If the user asked a question on this topic

φ_{answer}=If the user answered a question on this topic

φ_{Accepted}=If the user provided an answer on this topic that is accepted

M₁₁=Asked Question Modifier

M₁₂=Answered Question Modifier

M₁₃=Answer Accepted Modifier

It should be understood that Eqs. (1)-(4) are merely examples; many other events or conditions may be included in calculating the sub-scores.

Eqs. (1)-(3) require the mean or average and standard deviation of various values, including time for completion and test and scores, for all students. These values are calculated before the individual student scores are calculated.

After the sub-scores for test, homework, page work and forum related data are calculated using Eqs. (1)-(4), the values are combined by a weighted sum to calculate an overall academic ability score of the student on subject A, as shown below (Eq. (5)):

$$C = \frac{{C}_{1} + {w}_{2} {C}_{2} + {w}_{3} {C}_{3} + {w}_{4} {C}_{4}}{{\sum }_{i = 0}^{4} {N}_{i} {w}_{i}}$$

where w₀ to w₄ are the weights for quizzes, tests, homework tasks, page work tasks and forum questions, respectively; N₀ to N₄ are the numbers of quizzes, tests, homework tasks, page work tasks and forum questions, respectively, that are summed in Eqs. (1) to (4). As described earlier, the weights for quizzes and tests are absorbed into Eq. (1) (as values M₀ and M₁); they do not appear in Eq. (5). In one implementation, the weights w₀ to w₄ are 0.5, 1, 0.5, 0.25 and 0.25, respectively. Of course, these values are merely examples and any desirable weights can be used.

In one implementation, for convenience, the various modifier values in Eqs. (1) to (4) and the weights in Eq. (5) are designed so that most scores will fall within the range of 0 to 1, and scores outside of this range may be rounded to 0 or 1.

The above process is repeated for other subjects of study for this student, and repeated for all students. The scores are stored in a database.

The process of calculating the scores for all students in all subjects, described in detail above, is summarized in FIG. 2. As a result, the score for each student in each of their subjects of study is stored in the database, as schematically illustrated in FIG. 3.

The academic ability scores may be used to rate each student on each topic. For example, in the example of FIG. 3, student 1 is very good in topic A, good in topics D and E, average in topic C and poor in topic B; student 3 is poor or very poor in many topics; and student 4 is good or very good in many topics. Threshold levels may be set to rate each score as good, average and poor. In a particular example, a score of 0.7 or above is deemed good, a score of 0.3 or below is deemed bad, and a score between 0.3 and 0.7 is deemed average. In another example, a student with a score of 0.9 or above in a topic is rated as an expert in that topic, and a student with a score of 0.2 or below in a topic is rated as struggling in that topic.

Either the scores calculated by Eq. (5) or the ratings of each student on each subject may be stored in the database and used in the calculation of the user-pose relationship scores (step S12 of FIG. 1).

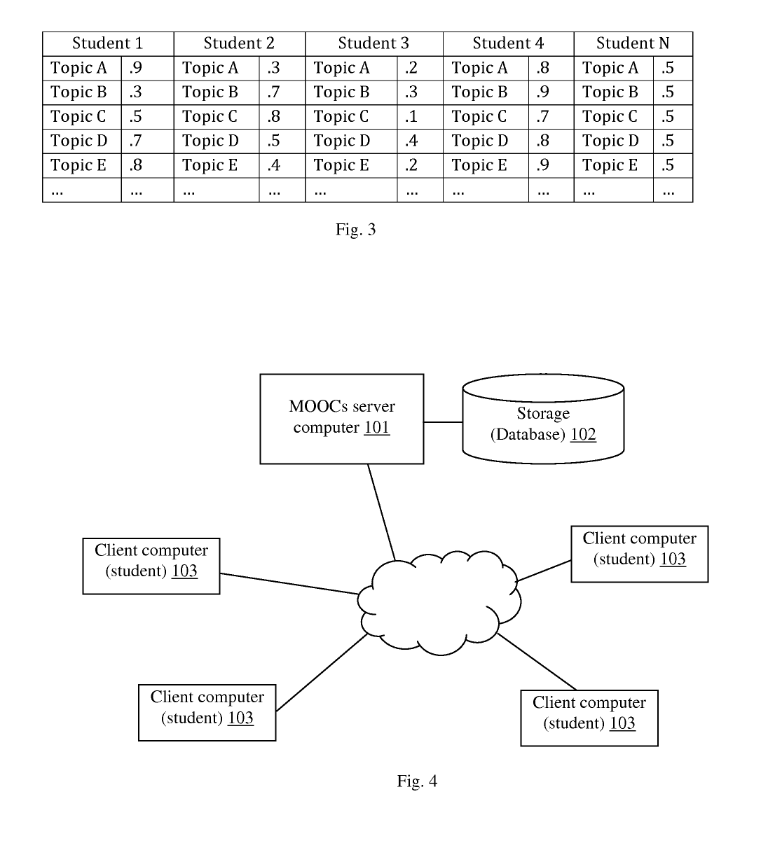

FIG. 4 schematically illustrates a MOOCs system in which the peer-review request assignment method of the embodiments or the present invention may be implemented. The system includes one or more MOOCs servers 101 that provides web-based educational materials, a storage 102 connected to the server storing the student information database, and multiple client computers 103 through which the students accesses the MOOCs server via a network. The server 101 includes processors and memories storing program code that implements the above described methods.

It will be apparent to those skilled in the art that various modification and variations can be made in the online forum management method and related apparatus of the present invention without departing from the spirit or scope of the invention. Thus, it is intended that the present invention cover modifications and variations that come within the scope of the appended claims and their equivalents.

What is claimed is:

1. A method implemented in a MOOCs (Massive Open Online Courses) system for processing questions posted on an online forum of the MOOCs system, the MOOCs system including one or more server computers providing web-based educational materials, the method being implemented on the server computers, comprising:
(a) storing, in a database, information about each of a plurality of students registered with the MOOCs system, including their academic abilities in each of a plurality of subjects of study;
(b) receiving a plurality of questions posted on the online forum;
(c) receiving a browsing command from a viewing student among the plurality of students to browse the forum;
(d) for each of the questions on the online forum, calculating a relationship score with respect to the viewing student based on stored academic ability of the viewing student in a subject of the question;
(e) in response to the browsing command from the viewing student, generating a sorted list of all forum questions in which the forum questions are sorted based at least partly on the relationship scores of the questions with respect to the viewing student; and
(f) transmitting the sorted list of all forum questions to the viewing student.

2. The method of claim 1, wherein in step (a), the database further stores each student's language and locale information, past forum activities information, and online access history, and
wherein the relationship score in step (d) is further based on the language and locale information, past forum activities information, and online access history.

3. The method of claim 2, wherein the online access history includes numbers of the viewing user's logon events on a 24 hour scale, and wherein the relationship score is based on a relative frequency of the logon events of the viewing student in a predetermined time period of the 24 hour scale centered at or starting from a time the question was posted.

4. The method of claim 1, further comprising, before step (a):
gathering academic information about each student regarding each subject including: test related data relating to tests taken by the student, homework related data relating to homework assignments done by the student, page work related data indicating time spent by the student on each page of study materials, and forum related data indicating numbers of forum questions asked or answered by the student;
calculating an academic ability score for each student regarding each subject using the gathered academic information; and
storing the academic ability scores;
wherein the relationship scores in step (d) are calculated using the academic ability scores.

5. A computer program product comprising a computer usable non-transitory medium having a computer readable program code embedded therein for controlling a data processing apparatus, the data processing apparatus forming a MOOCs (Massive Open Online Courses) system including one or more server computers providing web-based educational materials, the computer readable program code configured to cause the data processing apparatus to execute a process for processing questions posted on an online forum of the MOOCs system, the process comprising:
(a) storing, in a database, information about each of a plurality of students registered with the MOOCs system, including their academic abilities in each of a plurality of subjects of study;
(b) receiving a plurality of questions posted on the online forum;
(c) receiving a browsing command from a viewing student among the plurality of students to browse the forum;
(d) for each of the questions on the online forum, calculating a relationship score with respect to the viewing student based on stored academic ability of the viewing student in a subject of the question;
(e) in response to the browsing command from the viewing student, generating a sorted list of all forum questions in which the forum questions are sorted based at least partly on the relationship scores of the questions with respect to the viewing student; and
(f) transmitting the sorted list of all forum questions to the viewing student.

6. The computer program product of claim 5, wherein in step (a), the database further stores each student's language and locale information, past forum activities information, and online access history, and
wherein the relationship score in step (d) is further based on the language and locale information, past forum activities information, and online access history.

7. The computer program product of claim 6, wherein the online access history includes numbers of the viewing user's logon events on a 24 hour scale, and wherein the relationship score is based on a relative frequency of the logon events of the viewing student in a predetermined time period of the 24 hour scale centered at or starting from a time the question was posted.

8. The computer program product of claim 5, wherein the method further comprises, before step (a):
gathering academic information about each student regarding each subject including: test related data relating to tests taken by the student, homework related data relating to homework assignments done by the student, page work related data indicating time spent by the student on each page of study materials, and forum related data indicating numbers of forum questions asked or answered by the student;
calculating an academic ability score for each student regarding each subject using the gathered academic information; and
storing the academic ability scores;
wherein the relationship scores in step (d) are calculated using the academic ability scores.
